(19) United States
(12) Patent Application Publication
(10) Pub. No.: US 2005/0146826 A1
(43) Pub. Date: Jul. 7, 2005

(54) Safety power socket with overheating and overcurrent protection

(76) Inventor: Shang-Lung Huang, Tai Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/019,209

(22) Filed: Dec. 23, 2004

(30) Foreign Application Priority Data
Jan. 2, 2004 (TW) 93200059

(51) Int. Cl. H02H 5/04

(52) U.S. Cl. 361/104

(57) ABSTRACT

A safety power socket with overheating and overcurrent protection comprises a base, a cover body, two terminal blade receiving elements, two power conducting elements, and two low-melting-point alloy pieces with current-limit and heat-conduction functions. Two chambers are disposed on the base respectively. One terminal blade receiving element for insertion of a terminal blade of a plug and one power conducting element connecting with a power supply cable are disposed in each chamber. Each low-melting-point alloy piece is connected with the bottoms of one terminal blade receiving element and one power conducting element. The alloy piece can break and protect from overcurrent by means of the specific current density together with predetermined cross section thereof. The alloy piece can also break and protect from overheating by means of the low-melting-point feature as Joule heat accumulating due to incomplete power contact between the terminal blade receiving element and insertion plugs.

### BACKGROUND OF THE INVENTION

1. Field of the Invention

The present invention relates to a modified power socket and, more particularly, to a safety power socket with overheating and overcurrent protection.

2. Description of Related Art

According to the literature, many of residential fire accidents are related to the overheating of insulating resin in conventional power sockets. For examples, the loose power connection between plug and socket, due to elasticity fatigue caused by frequent insertion and removal of the plug, are a source of sparking and deterioration of the insulation resin and can lead to fires. Unfortunately, the overheating of insulating resin seldom trigger household circuit self-protection mechanisms, such as fuseless breakers.

The overheating of insulating resin in power sockets result from incomplete power contact or insulation failure of resin. Technically, incomplete power contact takes place when parts of the contactor's surface is oxidized, rusted or even accumulated with dusts, or when the elasticity of contractor is decreasing. Insulation failure of resin is often caused by a long period of overheating following by incomplete power contact.

As to conventional power sockets, fusing devices or detection circuits are much applied on overcurrent control. However, the fusing devices or detection circuits can not provide direct protection on the overheating of insulating resin in power sockets, and just like prevalent fuseless breakers installed on household power circuit can not be activated by the overheating.

Therefore, there is an urgent need to provide a feasible and cost-effective solution to the incomplete power contact or insulation failure of resin for power sockets.

### SUMMARY OF THE INVENTION

An object of the present invention is to provide a safety power socket with overheating and overcurrent protection.

To achieve the above object, the present invention proposes a safety power socket with overheating and overcurrent protection. The safety power socket comprises a base, two or more terminal blade receiving elements for plug insertion, two or more power conducting elements connecting with power supply cables, and two or more low-melting-point alloy pieces with heat-conduction and current-limit functions. The terminal blade receiving elements are disposed in the base.

The power conducting elements are disposed in the base and correspond to the terminal blade receiving elements. The low-melting-point alloy pieces are joined on the terminal blade receiving elements and the power conducting elements, and will break when overheated due to incomplete power contact between the terminal blade receiving elements and insertion plugs.

The above terminal blade receiving element is composed of a curved resilient arm and a sheet-shaped resilient leaf portion. A receiving space is formed between the resilient arm and the resilient leaf portion.

The above power conducting element is a copper conducting element.

The above alloy piece can be soldered to the bottoms of the terminal blade receiving element and the power conducting element.

The above alloy piece can also be welded at the bottoms of the terminal blade receiving sheet and the power conducting element.

A cover body is connected on the above base. Two or more power socket holes are formed on the cover body.

The alloy piece can break and protect from overcurrent by means of the specific current density together with predetermined cross section thereof. The alloy piece can also break and protect from overheating by means of the low-melting-point feature as Joule heat accumulating due to incomplete power contact between the terminal blade receiving element and insertion plugs. In addition, the alloy piece will break when overheating due to short circuit caused by insulation failure of resin.

Hence, the present invention can prevent sockets from overcurrent and overheating and provide safer residence.

In addition, the low-melting-point alloy generally breaks around the temperature of 67° C. Insulating resin can be perfectly intact per se and will not be jeopardized when the alloy breaks, because insulating resin can endure the temperature in excess of 90° C.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view of the present invention;

FIG. 2 is a cross-sectional view of the present invention after assembly;

FIG. 3 is a perspective assembly view of a terminal blade receiving element, a power conducting element, and an alloy piece of the present invention;

FIG. 4 is an exploded perspective view of FIG. 3;

FIG. 5 is a side view of FIG. 3;

FIG. 6 is a perspective assembly view of a terminal blade receiving element, a power conducting element, and an alloy piece according to a second embodiment of the present invention;

FIG. 7 is a side view of FIG. 6;

FIG. 8 is a perspective assembly view of a terminal blade receiving element, a power conducting element, and an alloy piece according to a third embodiment of the present invention; and

FIG. 9 is a side view of FIG. 8.

### DETAILED DESCRIPTION OF THE PREFERRED EMBODIMENTS

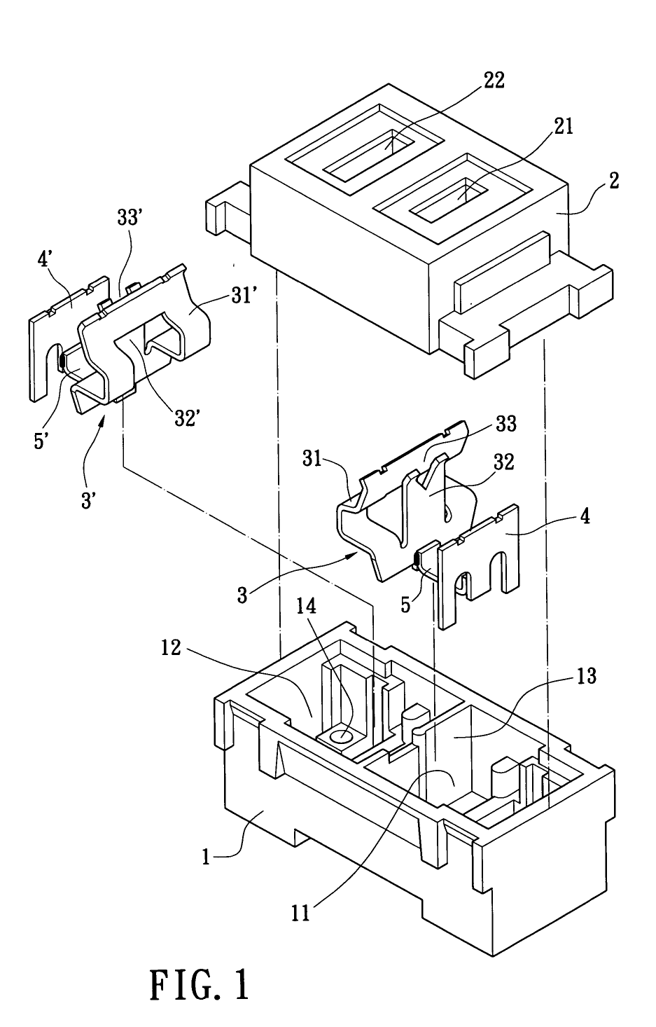

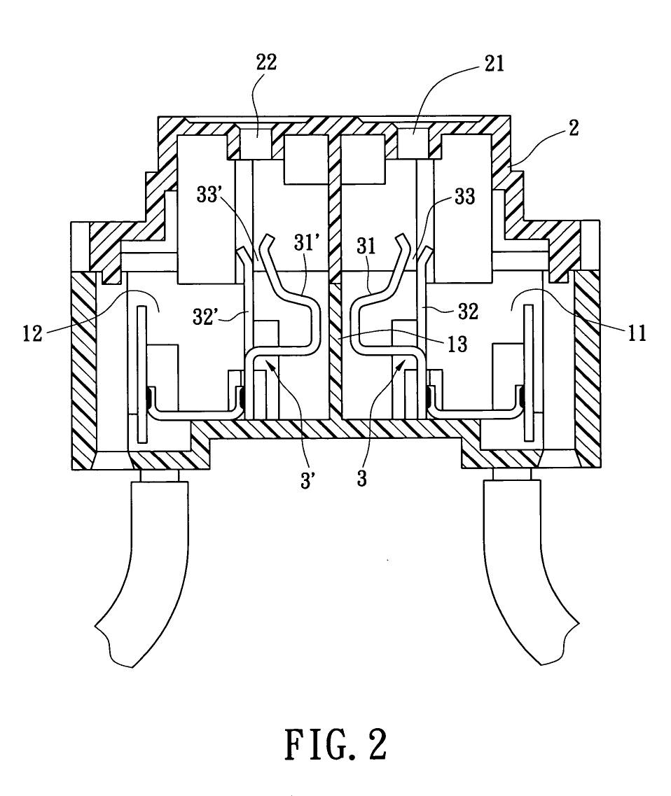

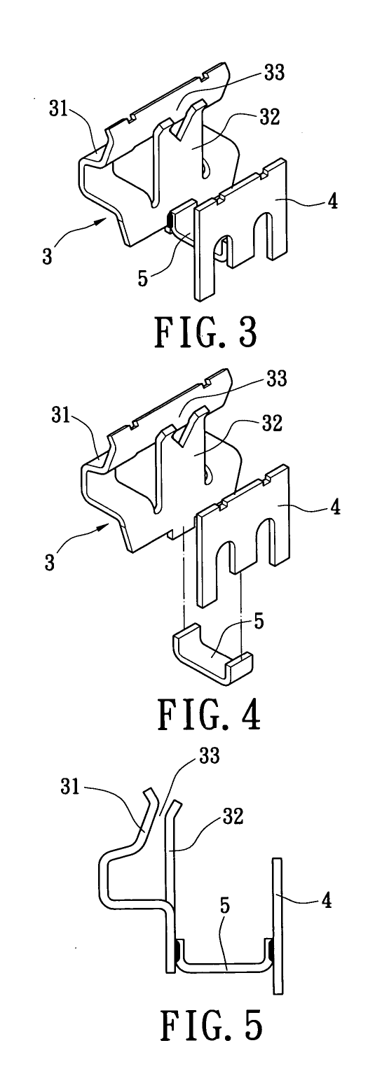

As shown in FIGS. 1 to 5, the present invention proposes a safety power socket with overheating and overcurrent protection. The present invention provides a cost-effective and feasible solution to the overheating of power sockets due to incomplete power contact or insulation failure of resin. The present invention can apply to two-hole or multi-hole power sockets. The present invention is primarily exemplified with two-hole power sockets. The power socket comprises a base 1, a cover body 2, two terminal blade receiving elements 3 and 3′, two power conducting elements 4 and 4′, and two alloy pieces 5 and 5′ with current-limit and heat-conduction functions.

The base 1 has two chambers 11 and 12. A shield piece 13 is disposed between the two chambers 11 and 12. Two cable holes 14 for insertion of power supply cables are disposed on the bottom face of each of the chambers 11 and 12.

The cover body 2 is joined on the base 1, and has two power socket holes 21 and 22 for guiding insertion of conducting pins (not shown) of a plug.

The two terminal blade receiving elements 3 and 3′ are disposed in the chambers 11 and 12, respectively. Each terminal blade receiving element 3 (3′) is composed of a curved resilient arm 31 (31′) and a sheet-shaped resilient leaf portion 32 (32′). A receiving space 33 (33′) is formed between the resilient arm 31 (31′) and the resilient leaf portion 32 (32′).

The two power conducting elements 4 and 4′ are disposed in the chambers 11 and 12 and keep a distance from the corresponding terminal blade receiving elements 3 and 3′, respectively. Each power conducting element 4 (4′) is a copper conducting sheet.

The two alloy pieces 5 and 5′ are soldered to the bottoms of the two terminal blade receiving elements 3 and 3′ and the two power conducting elements 4 and 4′, respectively. The alloy pieces 5 and 5′ are of a concave shape. Each alloy component 5 (5′) is a low-melting-point alloy piece such as a wood alloy piece. The wood alloy piece will immediately break when the temperature is higher than 67° C. Further, the alloy piece 5 (5′) can break and protect from overcurrent by means of the specific current density together with predetermined cross section thereof. The alloy piece 5 (5′) can also break and protect from overheating by means of the low-melting-point feature as Joule heat accumulating due to incomplete power contact between the terminal blade receiving element 3 (3′) with insertion plugs. The incomplete power contact takes place when parts of the contactor's (no matter sockets or plugs) surface is oxidized, rusted or even accumulated with dusts, or when the elasticity of the terminal blade receiving element 3 (3′) is decreasing. With the above characteristics of the alloy piece 5 (5′), the alloy piece 5 (5′) will break when overheating due to short circuit caused by insulation failure of resin.

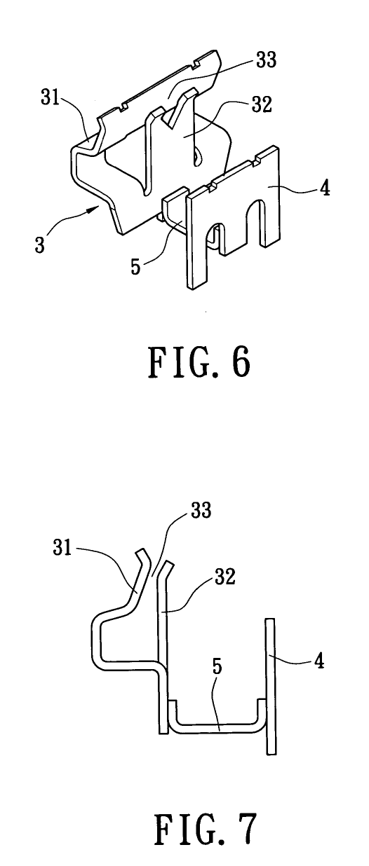

As shown in FIGS. 6 and 7, the alloy piece 5 (5′) of the present invention can also be welded together with the terminal blade receiving element 3 (3′) and the power conducting element 4 (4′).

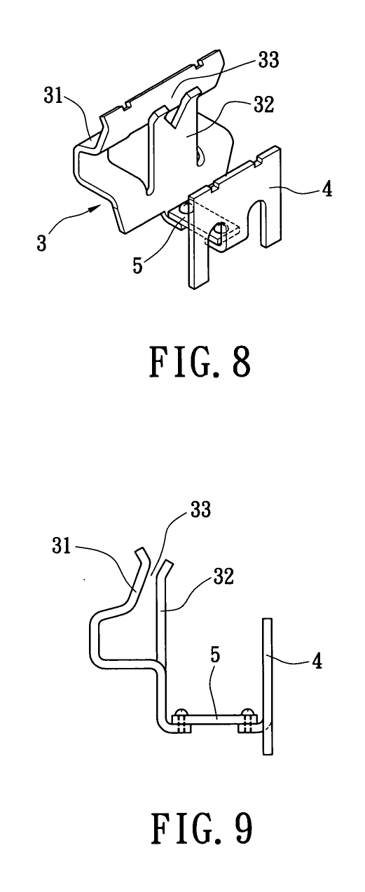

As shown in FIGS. 8 and 9, the alloy piece 5 (5′) of the present invention can also be screwed together with the terminal blade receiving element 3 (3′) and the power conducting element 4 (4′).

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A safety power socket with overheating and overcurrent protection comprising:
a base;
two or more than two terminal blade receiving elements for embedding of conducting pins of a plug, said terminal blade receiving elements being disposed in said base;
two or more than two power conducting elements connecting with power supply cables, said power conducting elements being also disposed in said base and corresponding to said terminal blade receiving elements; and
two or more than two low-melting-point alloy pieces with heat-conduction and current-limit functions, said low-melting-point alloy pieces being joined on said terminal blade receiving elements and said power conducting elements;
whereby said low-melting-point alloy pieces will break either when overcurrent or overheating due to incomplete power contact between said terminal blade receiving element and insertion plugs, caused by surface oxidation or accumulated particles or fatigue behavior of elasticity.

2. The safety power socket with overheating and overcurrent protection as claimed in claim 1, wherein said alloy piece has a low melting-point.

3. The safety power socket with overheating and overcurrent protection as claimed in claim 1, wherein said alloy piece is a wood alloy piece.

4. The safety power socket with overheating and overcurrent protection as claimed in claim 1, wherein said alloy piece is of a concave shape.

5. The safety power socket with overheating and overcurrent protection as claimed in claim 1, wherein each of said terminal blade receiving elements is composed of a curved resilient arm and a sheet-shaped resilient leaf portion, and a receiving space is formed between said resilient arm and said resilient leaf portion.

6. The safety power socket with overheating and overcurrent protection as claimed in claim 1, wherein said power conducting element is a copper conducting sheet.

7. The safety power socket with overheating and overcurrent protection as claimed in claim 1, wherein said alloy piece can be soldered to the bottoms of said terminal blade receiving element and said power conducting element.

8. The safety power socket with overheating and overcurrent protection as claimed in claim 1, wherein said alloy piece can be welded at the bottoms of said terminal blade receiving element and said power conducting element.

9. The safety power socket with overheating and overcurrent protection as claimed in claim 1, wherein said alloy piece can be screwed to the bottoms of said terminal blade receiving element and said power conducting element.

10. The safety power socket with overheating and overcurrent protection as claimed in claim 1, wherein a cover body is connected on said base, and two or more than two power socket holes are formed on said cover body.
